(19) United States
(12) Patent Application Publication
(10) Pub. No.: US 2025/0130917 A1
(43) Pub. Date: Apr. 24, 2025

(54) TELEMETRY DATA CORRELATION IN A COMPUTING SYSTEM

(71) Applicants: John J. Browne, Limerick (IE); Marcos E. Carranza, Portland, OR (US); Francesc Guim Bernat, Barcelona (ES); Rajesh Poornachandran, Portland, OR (US); Stephen T. Palermo, Paradise Valley, AZ (US)

(72) Inventors: John J. Browne, Limerick (IE); Marcos E. Carranza, Portland, OR (US); Francesc Guim Bernat, Barcelona (ES); Rajesh Poornachandran, Portland, OR (US); Stephen T. Palermo, Paradise Valley, AZ (US)

(21) Appl. No.: 19/001,795

(22) Filed: Dec. 26, 2024

(51) Int. Cl. G06F 11/34; G06F 21/53

(52) U.S. Cl. CPC G06F 11/3433; G06F 11/3495; G06F 21/53

(57) ABSTRACT

A telemetry manager collects in-band telemetry data and out-of-band telemetry data for an application from a plurality of telemetry sources associated with a plurality of different hardware components in a system. The telemetry manager identifies a subset of hardware components in the plurality of hardware components of the system used to handle workloads of the application and correlates the telemetry data associated with the workloads handled by the subset of hardware components. The telemetry manager triggers a reconfiguration of at least one of the application or the subset of hardware components based on the correlation of the telemetry data.

### BACKGROUND

A data center may include one or more platforms each comprising at least one processor and associated memory modules. Each platform of the datacenter may facilitate the performance of any suitable number of processes associated with various applications running on the platform. These processes may be performed by the processors and other associated logic of the platforms. Each platform may additionally include I/O controllers, such as network adapter devices, which may be used to send and receive data on a network for use by the various applications.

Edge computing, including mobile edge computing, may offer application developers and content providers cloud-computing capabilities and an information technology service environment at the edge of a network. Edge computing may have some advantages when compared to traditional centralized cloud computing environments. For example, edge computing may provide a service to a user equipment (UE) with a lower latency, a lower cost, a higher bandwidth, a closer proximity, or an exposure to real-time radio network and context information.

### BRIEF DESCRIPTION OF THE FIGURES

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a simplified block diagram illustrating example components of a data center.

FIG. 2 is a simplified block diagram illustrating an example computing system.

FIG. 3 is an example approach for networking and services in an edge computing system.

FIG. 4 is a simplified block diagram illustrating an example computing device.

FIG. 5 is a simplified block diagram illustrating an example computing system.

FIG. 6 is a simplified block diagram illustrating an example scale-out computing architecture.

FIG. 7 is a simplified block diagram illustrating an example telemetry manager in a computing system.

FIG. 8 is a simplified block diagram illustrating an example computing node in a system including a telemetry manager.

FIG. 9 is a simplified diagram illustrating principles of time-based correlation of in-band and out-of-band telemetry data within a computing system.

FIG. 10 is a simplified flow diagram illustrating the example provisioning of attestation credentials for a trusted execution environment (TEE).

FIG. 11 illustrates a block diagram of an example processor device in accordance with certain embodiments.

Like reference numbers and designations in the various drawings indicate like elements.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

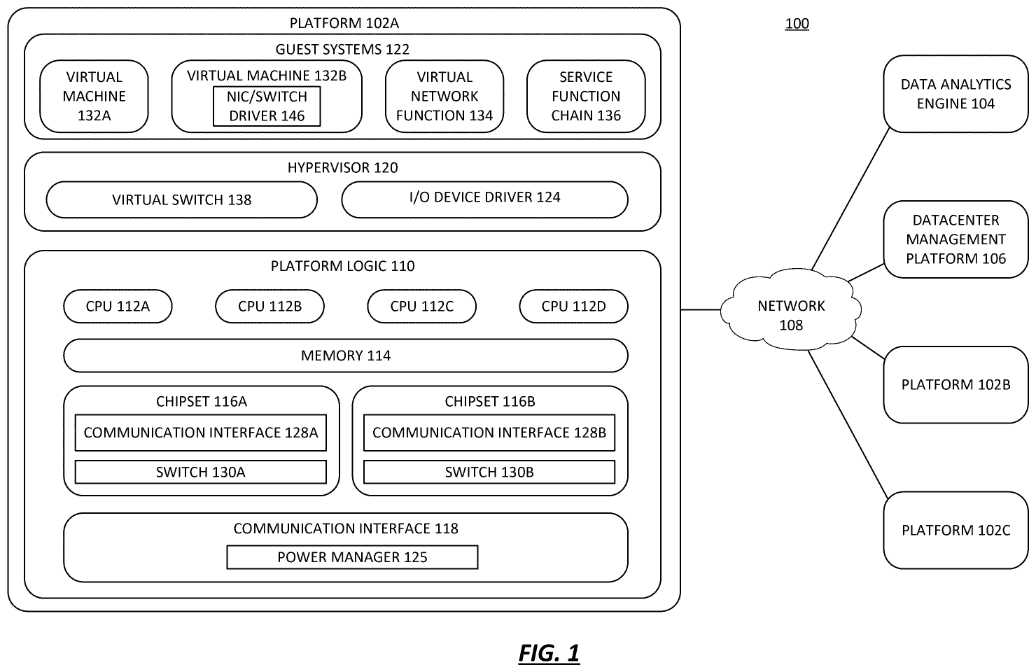

FIG. 1 illustrates a block diagram of components of a datacenter 100 in accordance with certain embodiments. In the embodiment depicted, datacenter 100 includes a plurality of platforms (e.g., 102B-102C), data analytics engine 104, and datacenter management platform 106 coupled together through network 108. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. The platform may include a telemetry manager 150, such as discussed in more detail herein, which may be used to collect telemetry data and perform time-based correlation of in-band telemetry data with out-of-band telemetry data (e.g., captured from other platforms (e.g., 102B, 102C, etc.) to provide improved detection of performance issues within the system, among other example enhancements.

Each platform 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that comprises multiple platforms coupled together through network 108 (which may comprise, e.g., a rack or backplane switch).

CPUs 112 may each comprise any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removably coupled to platform 102. Although four CPUs are shown, a platform 102 may include any suitable number of CPUs.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may each comprise memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 comprising any suitable logic to support the operation of the CPUs 112. In various embodiments, chipset 116 may reside on the same package as a CPU 112 or on one or more different packages. Each chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on each CPU.

Chipsets 116 may each include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (e.g., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, NVLink, Ultra Path Interconnect (UPI), Universal Chiplet Interconnect Express (UCIe), and others, which may each alternatively or collectively apply the general principles and/or specific features discussed herein. Switch 130 may be a physical or virtual (e.g., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (e.g., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. Each platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports).

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the data system 100 may be coupled together in any suitable manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

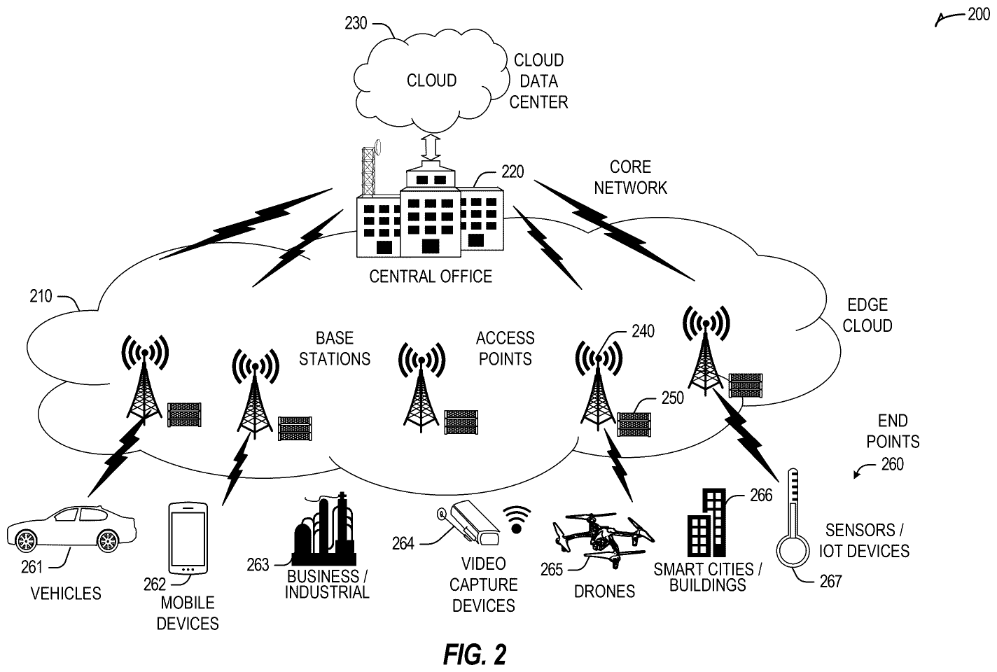

A data center, such as introduced above, may be utilized in connection with a cloud, edge, machine-to-machine, or IoT system. Indeed, principles of the solutions discussed herein may be employed in datacenter systems (e.g., server platforms) and/or devices utilized to implement a cloud, edge, or IoT environment, among other example computing environments. For instance, FIG. 2 is a block diagram 200 showing an overview of a configuration for edge computing, which includes a layer of processing referred to in many of the following examples as an “edge cloud” or “edge system”. As shown, the edge cloud 210 is co-located at an edge location, such as an access point or base station 240, a local processing hub 250, or a central office 220, and thus may include multiple entities, devices, and equipment instances. The edge cloud 210 is located much closer to the endpoint (consumer and producer) data sources 260 (e.g., autonomous vehicles 261, user equipment 262, business and industrial equipment 263, video capture devices 264, drones 265, smart cities and building devices 266, sensors and IoT devices 267, etc.) than the cloud data center 230. Compute, memory, and storage resources which are offered at the edges in the edge cloud 210 may be leveraged to provide ultra-low latency response times for services and functions used by the endpoint data sources 260 as well as reduce network backhaul traffic from the edge cloud 210 toward cloud data center 230 thus improving energy consumption and overall network usages among other benefits.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 210. Within the context of this disclosure, telemetry data may be collected in association with the various devices (and their constituent subsystems and components) in an edge computing systems, such as shown in the example of FIG. 2.

As such, an edge cloud 210 may be formed from network components and functional features operated by and within edge gateway nodes, edge aggregation nodes, or other edge compute nodes among network layers. An edge cloud 210 may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 210 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks.

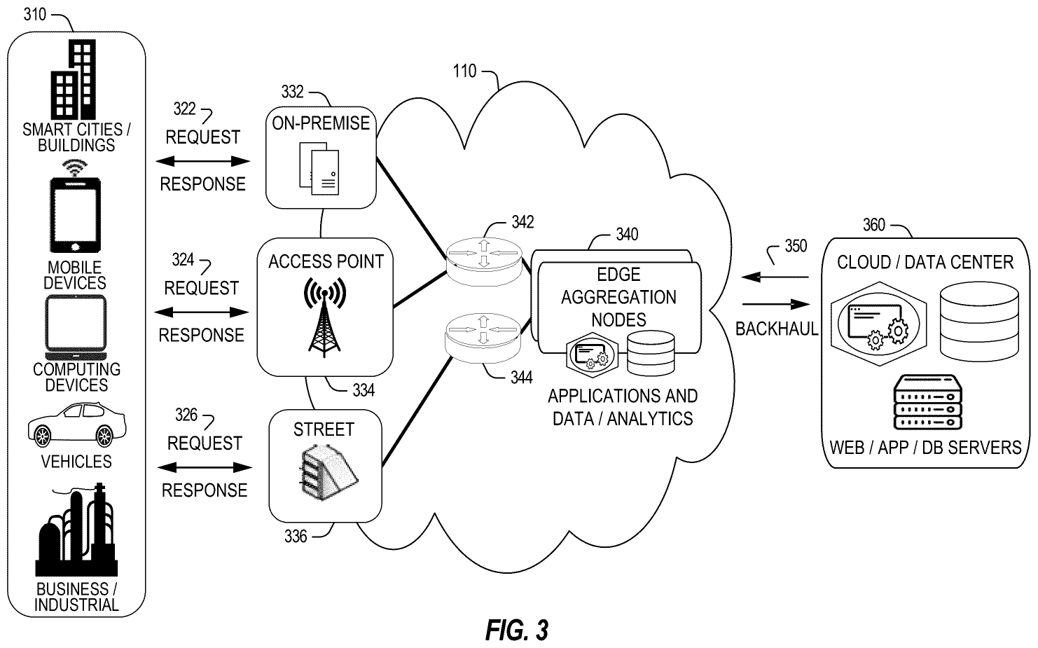

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., a cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 210 to aggregate traffic and requests. Thus, within the edge cloud 210, the TSP may deploy various compute and storage resources, such as at edge aggregation nodes 340, to provide requested content. The edge aggregation nodes 340 and other systems of the edge cloud 210 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 210 or other areas of the TSP infrastructure. Such aggregation points may also be leveraged for the collection of various telemetry data collected from the various devices within an example cloud, IoT, or edge system, among other example uses.

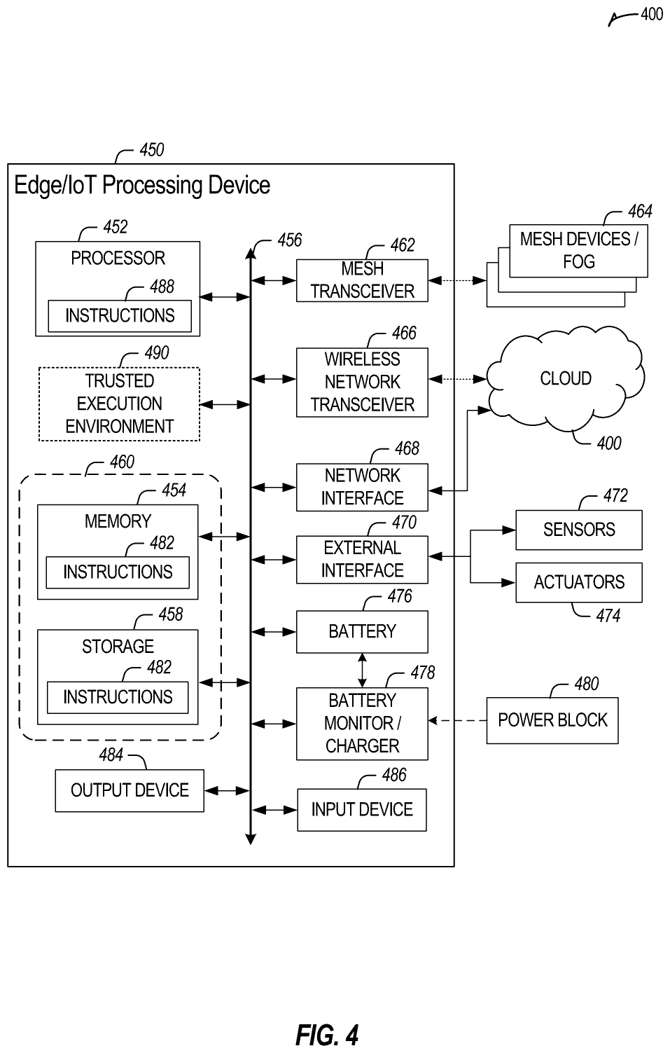

FIG. 4 is a block diagram of an example of components that may be present in an example edge computing device 450 for implementing the techniques described herein. The edge device 450 may include any combinations of the components shown in the example or referenced in the disclosure above. The components may be implemented as ICs, intellectual property blocks, portions thereof, discrete electronic devices, or other modules, logic, hardware, software, firmware, or a combination thereof adapted in the edge device 450, or as components otherwise incorporated within a chassis of a larger system. Such example computing devices may include one or more telemetry sensors to monitor components of the edge computing device 450 and generate corresponding telemetry data (which may be shared with a telemetry manager, as discussed herein). Additionally, the block diagram of FIG. 4 is intended to depict a high-level view of components of the edge device 450. However, some of the components shown may be omitted, additional components may be present, and different arrangements of the components shown may occur in other implementations.

The edge device 450 may include processor circuitry in the form of, for example, a processor 452, which may be a microprocessor, a multi-core processor, a multithreaded processor, an ultra-low voltage processor, an embedded processor, or other known processing elements. The processor 452 may be a part of a system on a chip (SoC) in which the processor 452 and other components are formed into a single integrated circuit, or a single package. The processor 452 may communicate with a system memory 454 over an interconnect 456 (e.g., a bus). Any number of memory devices may be used to provide for a given amount of system memory. To provide for persistent storage of information such as data, applications, operating systems and so forth, a storage 458 may also couple to the processor 452 via the interconnect 456. In an example the storage 458 may be implemented via a solid state disk drive (SSDD). Other devices that may be used for the storage 458 include flash memory cards, such as SD cards, microSD cards, xD picture cards, and the like, and USB flash drives. In low power implementations, the storage 458 may be on-die memory or registers associated with the processor 452. However, in some examples, the storage 458 may be implemented using a micro hard disk drive (HDD). Further, any number of new technologies may be used for the storage 458 in addition to, or instead of, the technologies described, such resistance change memories, phase change memories, holographic memories, or chemical memories, among others.

The components may communicate over the interconnect 456. The interconnect 456 may include any number of technologies, including PCI express (PCIe), Compute Express Link (CXL), NVLink, HyperTransport, or any number of other technologies. The interconnect 456 may be a proprietary bus, for example, used in a SoC based system. Other bus systems may be included, such as an 12C interface, an SPI interface, point to point interfaces, and a power bus, among others.

Given the variety of types of applicable communications from the device to another component or network, applicable communications circuitry used by the device may include or be embodied by any one or more of components 462, 466, 468, or 470. Accordingly, in various examples, applicable means for communicating (e.g., receiving, transmitting, etc.) may be embodied by such communications circuitry. For instance, the interconnect 456 may couple the processor 452 to a mesh transceiver 462, for communications with other mesh devices 464. The mesh transceiver 462 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. The mesh transceiver 462 may communicate using multiple standards or radios for communications at different ranges.

A wireless network transceiver 466 may be included to communicate with devices or services in the cloud 400 via local or wide area network protocols. For instance, the edge device 450 may communicate over a wide area using LoRaWAN™ (Long Range Wide Area Network), among other example technologies. Indeed, any number of other radio communications and protocols may be used in addition to the systems mentioned for the mesh transceiver 462 and wireless network transceiver 466, as described herein. For example, the radio transceivers 462 and 466 may include an LTE or other cellular transceiver that uses spread spectrum (SPA/SAS) communications for implementing high speed communications. Further, any number of other protocols may be used, such as Wi-Fi® networks for medium speed communications and provision of network communications. A network interface controller (NIC) 468 may be included to provide a wired communication to the cloud 400 or to other devices, such as the mesh devices 464. The wired communication may provide an Ethernet connection, or may be based on other types of networks, protocols, and technologies.

The interconnect 456 may couple the processor 452 to an external interface 470 that is used to connect external devices or subsystems. The external devices may include sensors 472, such as accelerometers, level sensors, flow sensors, optical light sensors, camera sensors, temperature sensors, a global positioning system (GPS) sensors, pressure sensors, barometric pressure sensors, and the like. The external interface 470 further may be used to connect the edge device 450 to actuators 474, such as power switches, valve actuators, an audible sound generator, a visual warning device, and the like.

The storage 458 may include instructions 482 in the form of software, firmware, or hardware commands to implement the workflows, services, microservices, or applications to be carried out in transactions of an edge system, including techniques described herein. Although such instructions 482 are shown as code blocks included in the memory 454 and the storage 458, it may be understood that any of the code blocks may be replaced with hardwired circuits, for example, built into an application specific integrated circuit (ASIC). In some implementations, hardware of the edge computing device 450 (separately, or in combination with the instructions 488) may configure execution or operation of a trusted execution environment (TEE) 490. In an example, the TEE 490 operates as a protected area accessible to the processor 452 for secure execution of instructions and secure access to data, among other example features.

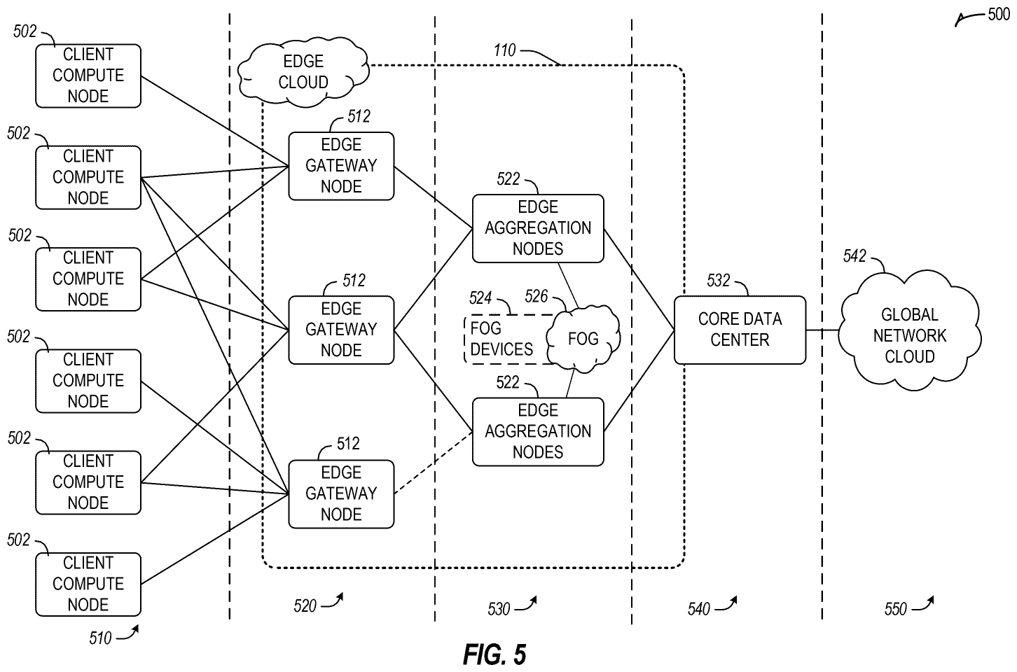

FIG. 5 provides a further abstracted overview of layers of distributed compute, including a data center or cloud and edge computing devices. For instance, FIG. 5 generically depicts an edge computing system for providing edge services and applications to multi-stakeholder entities, as distributed among one or more client compute nodes 502, one or more edge gateway nodes 512, one or more edge aggregation nodes 522, one or more core data centers 532, and a global network cloud 542, as distributed across layers of the network. The implementation of the edge computing system may be provided at or on behalf of a telecommunication service provider (“telco”, or “TSP”), internet-of-things service provider, cloud service provider (CSP), enterprise entity, or any other number of entities.

Each node or device of the edge computing system is located at a particular layer corresponding to layers 510, 520, 530, 540, 550. For example, the client compute nodes 502 are each located at an endpoint layer 510, while each of the edge gateway nodes 512 are located at an edge devices layer 520 (local level) of the edge computing system. Additionally, each of the edge aggregation nodes 522 (and/or fog devices 524, if arranged or operated with or among a fog networking configuration 526) are located at a network access layer 530 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein are applicable to fog networks, fogging, and fog configurations. Further, aspects of the edge computing systems discussed herein may be configured as a fog, or aspects of a fog may be integrated into an edge computing architecture.

The core data center 532 is located at a core network layer 540 (e.g., a regional or geographically-central level), while the global network cloud 542 is located at a cloud data center layer 550 (e.g., a national or global layer). The use of “core” is provided as a term for a centralized network location—deeper in the network—which is accessible by multiple edge nodes or components; however, a “core” does not necessarily designate the “center” or the deepest location of the network. Accordingly, the core data center 532 may be located within, at, or near the edge cloud 210.

Although an illustrative number of client compute nodes 502, edge gateway nodes 512, edge aggregation nodes 522, core data centers 532, global network clouds 542 are shown in FIG. 5, it should be appreciated that the edge computing system may include more or fewer devices or systems at each layer. Additionally, as shown in FIG. 5, the number of components of each layer 510, 520, 530, 540, 550 generally increases at each lower level (i.e., when moving closer to endpoints). As such, one edge gateway node 512 may service multiple client compute nodes 502, and one edge aggregation node 522 may service multiple edge gateway nodes 512.

In some examples, the edge cloud 210 may form a portion of or otherwise provide an ingress point into or across a fog networking configuration 526 (e.g., a network of fog devices 524, not shown in detail), which may be embodied as a system-level horizontal and distributed architecture that distributes resources and services to perform a specific function. For instance, a coordinated and distributed network of fog devices 524 may perform computing, storage, control, or networking aspects in the context of an IoT system arrangement. Other networked, aggregated, and distributed functions may exist in the edge cloud 210 between the cloud data center layer 550 and the client endpoints (e.g., client compute nodes 502).

The edge gateway nodes 512 and the edge aggregation nodes 522 cooperate to provide various edge services and security to the client compute nodes 502. Furthermore, because each client compute node 502 may be stationary or mobile, each edge gateway node 512 may cooperate with other edge gateway devices to propagate presently provided edge services and security as the corresponding client compute node 502 moves about a region. To do so, each of the edge gateway nodes 512 and/or edge aggregation nodes 522 may support multiple tenancy and multiple stakeholder configurations, in which services from (or hosted for) multiple service providers and multiple consumers may be supported and coordinated across a single or multiple compute devices.

Data centers and edge platforms may involve the inclusion and coupling of a variety of different devices from various vendors, which include various hardware, processors (generically referred to herein as XPUs), memory resources, I/O and networking resources (e.g., utilizing multiple different protocols to facilitate the interconnections), and running various software and firmware. Such heterogenous systems may enable an increasing variety of innovative solutions and applications. However, it is not only a technical challenge to build solutions to reliable couple and coordinate operations of systems, but also to track the performance and errors within such heterogenous systems.

Telemetry is used with heterogenous computing environments, such as data centers, cloud computing, and edge computing environments, to enable managers to monitor, analyze, and optimize the performance and health of their respective systems. Telemetry involves the collection, transmission, and analysis of data from various components within the system, the data reporting on the actions, attributes, and outcomes of these various components, such as servers, network devices, storage systems, and power supplies. Such data can be captured by various sensors provisioned within and observing both software and hardware components of the system. This telemetry data can provide real-time insights into system behavior and may be used to identify performance bottlenecks, predict potential failures or bandwidth issues, ensure efficient resource utilization, among other example uses. With the ever-increasing scale and complexity of data centers, telemetry solutions are becoming correspondingly complex in order to maintain high availability, reliability, and cost-effectiveness of the system.

Telemetry can be collected at the application or service level, for instance, to measure the performance of the code executed to implement the application, the performance of processor and memory resources directly accessed or used by the application, the performance of the execution environment (e.g., operating system, virtual machine, container, hypervisor, etc.) used to implement the application. This telemetry data may be collected within the same computing domain as the application and include information has a right to access and view (as the data is collected in connection with the host system, which executes the application. Such telemetry data may be considered “in-band” telemetry data. On the other hand, operation of an application may involve a variety of activities, operations, and systems, which are not coupled to the application's host or the host's execution environment and resources used to execute the application. For instance, an application may open a socket and engage in network communications with another system including other XPUs, accelerators, memory devices, or other hardware not used in the execution of the application. Such network communications may be carried over a variety of different network elements (e.g., routers, switches, base stations, NICs, etc.). The communications may engage with other applications (e.g., clients or servers), which are executed in their own independent execution environments on their own respective hosts. Telemetry data may be generated by these various components based on the application's activities. Telemetry data that falls outside of the execution of the application (e.g., the execution environment used, the application's own code, the host resources used, etc.) may be considered as “out of band” telemetry data. Such out-of-band telemetry data may even include telemetry data generated at the application's host, such as telemetry associated with a different execution environment (e.g., different virtual machine, virtual function, etc.) or telemetry data that is not specific to the application's operation (e.g., data collected regarding the general health and performance of a host or memory subsystem but not directly attributable to the application (e.g., system temperature, power usage, etc.).

Providing end-to-end telemetry in moderns systems can be difficult or impossible in existing distributed computing environments given the heterogeneity of such systems and multiple systems and parties involved in some application transactions. For instance, in broad-based virtual machine deployments across fleets of servers across different types and generations of XPUs (e.g., combinations of XPUs such as CPUs, smartNICs, GPUs, general purpose computing GPUs (GPGPUs), tensor processor units (TPUs), ASICs, FPGAs, infrastructure processing units (IPU), data processing units (DPUs), memory processing units (MPUs), etc.), not only will a variety of different telemetry data be generated within a variety of different systems, confidentiality and privacy policies and requirements (e.g., enforced by cloud service providers (CSPs) may result in vast swaths of telemetry data being abstracted or protected, resulting in limited access and use of such telemetry data.

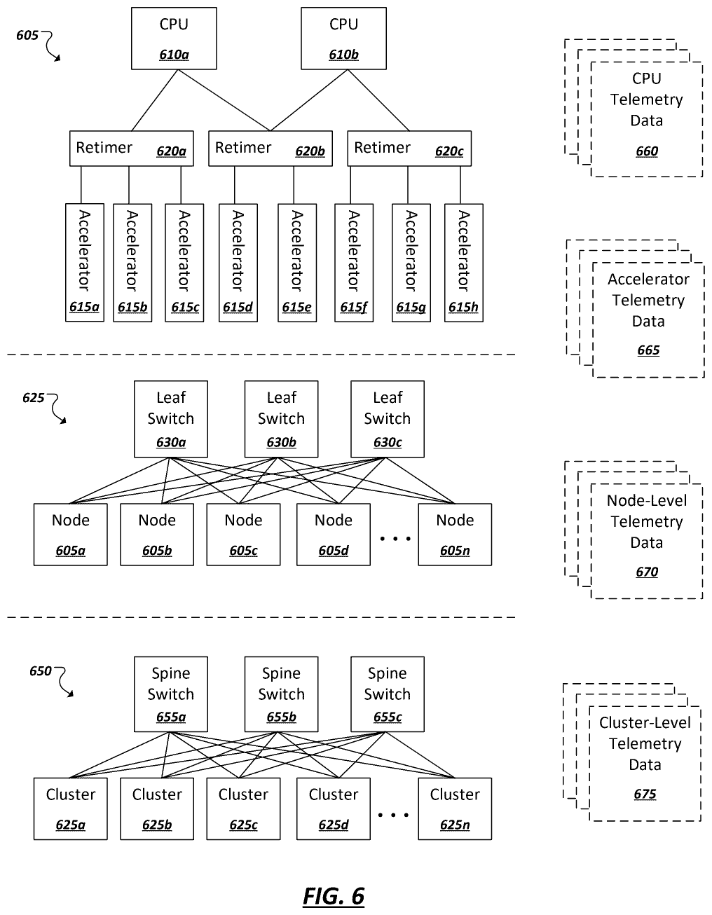

Turning to FIG. 6, a simplified block diagram is shown illustrating an example data infrastructure (e.g., for deployment within an example data center or other computing environment). In this example, processors nodes (e.g., 605) are implemented as a two-socket node to include two processor devices 610a-b (e.g., Xeon™ core processors) capable of interconnecting (e.g., via a set of retimer devices 620a-c) with eight accelerator XPUs 615a-h (e.g., machine learning processors, GPUs, etc.) in the node 605. A cluster 625 of nodes (e.g., 605a-n) may be implemented in scale-out fashion (e.g., with up to sixteen nodes forming a cluster 625), the nodes 605a-n, in this example, connected through example leaf switches (e.g., 630a-c). Clusters (e.g., 625a-n) may likewise be interconnected in a network of clusters 650, for instance, as a supercluster, federated cluster, or cluster mesh, interconnect by various network elements 655a-c (e.g., spine switches), among other examples. Each of the various XPUs and components included in the network of devices 650 (e.g., Gen AI GPU, GPGPUs, NICs, switches, CPUs, IPUs, etc.) may include sensors or agents to independently generate telemetry data (e.g., 660, 665, 670, 678) at the respective hardware and/or software and the telemetry data may represent different components (e.g., CPU, accelerator, switch, retimer, etc.) or system levels (e.g., node level, cluster level, network level, etc.). Some of the telemetry may include in-band telemetry data, with other telemetry being out-of-band telemetry data. Some telemetry data may always be in-band telemetry data (e.g., at least for a specific execution environment or application), while other telemetry data is out-of-band for all applications (e.g., telemetry data collected from switches, routers, NICs, shared accelerator hardware, etc. that is used in the “background” of the various applications that might be run on the system.), among other examples. Coordinating and correlating this variety and volume of telemetry data may present a challenge to modern systems.

In an improved implementation, a telemetry manager may be provided, which is configured to collect telemetry data, including both in-band and out-of-band telemetry data, from across a network of devices (e.g., in a data center, IoT, or edge computing environments) and correlate the telemetry data to provide effective insights on the bottlenecks, compute performance, memory performance, I/O performance, power-performance tradeoffs, among other examples. The telemetry data may be correlated to correlate all in-band telemetry data generated between all of the XPUs and components in the system, correlate all of the out-of-band telemetry data generated between all of the XPUs and components in the system, as well as correlate in-band and out-of-band telemetry data generated between the XPUs and components in the system.

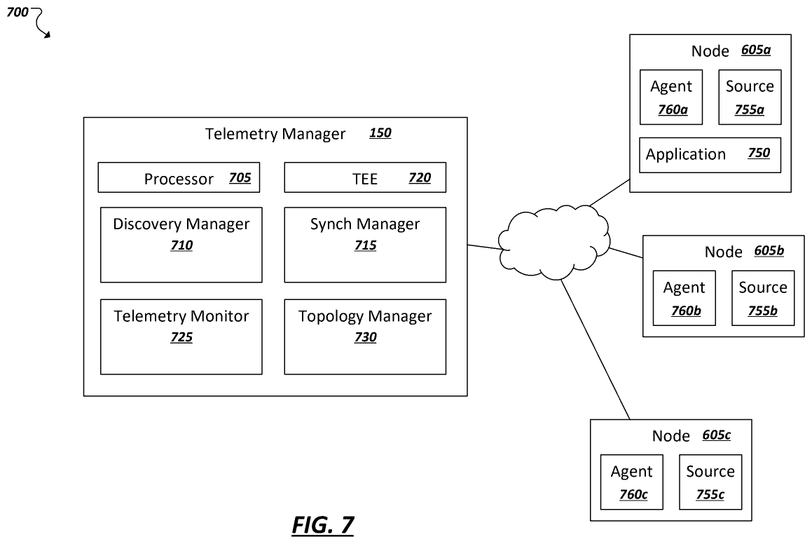

Turning to the simplified block diagram 700 of FIG. 7, an example telemetry manager 150 is provided, enhanced to correlate (e.g., for a given application, service, or process) in-band and out-of-band telemetry data relevant to a given application (e.g., application 750 executed or hosted on node 605a). In one example, the telemetry manager 150 may include a processor 705 to execute one or more modules implemented in hardware, firmware, or software. For instance, a discovery manager 710 may be provided that functions to discover the available in-band and out-of-band telemetry capabilities across XPUs and components across a system. In some implementations, the telemetry manager 150 may be provided for a given cluster and may be implemented within or in connection with a baseboard management controller (BMC) associated with the cluster. The processor 705 may be a microcontroller separate from the XPUs for which the telemetry manager 150 is to collect and correlate telemetry data, among other examples. The discovery manager 710 may identify the sensors (or other telemetry sources (e.g., 755a-c) provided on the various system components (e.g., nodes 605a-c)) and telemetry data types that might be generated by the sensors or otherwise at various components of the cluster.

The telemetry manager 150 may additionally include a trusted timestamp synchronization manager 715 to determine a synchronization or time-based correlation between various telemetry sources. For instance, the timestamp synchronization manager 715 may utilize time-sensitive networking (TSN) to align the start-stop of the various telemetry markers across all the XPUs or nodes (e.g., 605a-c). This may be performed by aligning both in-band and out-of-band telemetry data using Precision Time Protocol (PTP) or another precision timestamping protocol (e.g., White Rabbit, Chronos Protocol, Synchronized Ethernet (SyncE), etc.). The timestamp synchronization manager 715 facilitates the time alignment securely across the XPUs to allow precise correlation of the telemetry, while preserving confidentiality and privacy across different workload owners (e.g., in a public cloud). In some implementations, at least a portion of the telemetry manager 150 may be implemented with a hardware-hardened trusted execution environment (TEE) 720, where certain operations may be performed where security and privacy of telemetry data collected from various XPU services is to be guaranteed. For instance, at least some of the sources of telemetry data within a cluster may utilize encryption or encrypted communication channels to pass telemetry data to the telemetry manager 150. In such instances, the TEE 720 may be utilized to perform encryption and decryption in association with telemetry data provided to the telemetry manager and any cleartext data may be locked within the TEE so that it is not exposed to any other entity other than the owner of the telemetry data. This may allow timestamp information to also be extracted from various telemetry data, which might otherwise not be made available for use in correlating telemetry data across multiple XPUs, domains, and execution environments. For instance, telemetry data may be encrypted using a unique session key (e.g., using homomorphic encryption) and the preservation of privacy and confidentiality of this data may be policed utilizing the TEE 720. For instance, in a confidential multi-party collaborative computing environment, instead of raw telemetry, inferred telemetry affinity (e.g. rather than sharing observed core frequency, providing a higher score towards core boundness) may be determined and utilized.

An example telemetry manager 150 may additionally include a telemetry monitor 725 to continuously monitor network traffic and quality of service (QoS) metrics across individual XPUs based on the telemetry data obtained from these XPUs. The telemetry monitor 725 may detect or predict issues within the system based on the monitored telemetry data (e.g., utilizing a trained neural network model or other machine learning model) and trigger a reconfiguration of one or more applications or services deployed or to be deployed on a system to remedy or avoid the detected issues. For instance, the telemetry monitor 725 may detect, from the correlated telemetry data, one or more issues that may affect performance of a given application to be executed on the system and may trigger a change to the configuration or deployment of the given application based on this information (e.g., transition the deployment from microservices to a monolithic setup or hybrid model, etc.). For instance, the telemetry monitor 725 may detect issues including events (e.g., corresponding to or reporting one or more failed requests), memory usage and processing load saturation (e.g., when a processor or memory resource reaches 100% utilization or another threshold level of high utilization), response time issues relating to latency (e.g., the time utilized to process a request), and throughput or traffic (e.g., the number of requests that can be processed in a given time window (e.g., per minute, per second, etc.)), among other example information. In some implementations, such issues may be embodied within implementations of the “Golden Signals” of Errors, Saturation, Latency, and Traffic. Such signals (and other telemetry information) may be monitored and can be used to detect and predict infrastructure bottlenecks. Such telemetry signals may be independent of the workload, but may be combined with key performance indicators (KPI) metrics for the application workload and serve as the basis of the telemetry monitoring making predictions to avoid current and future performance issues (e.g., detecting instances of a Noisy Neighbor problem, where one tenant's workload may be negative impacting another tenant's performance in environments such as public cloud). Other telemetry metrics may be combined, such as I/O metrics (e.g., disk I/O operations, accelerator I/O, etc.), system logs (e.g., including error and audit logs), power consumption metrics, cache utilization metrics, memory bandwidth metrics, over-the-air interference metrics (e.g., Reference Signal Received Power (RSRP), Reference Signal Received Quality (RSRQ), Bit Error Ratio (BER), etc.), hardware accelerator utilization metrics, among other examples.

In some implementations, the telemetry manager 150 may additionally include a topology manager 730, which takes direction (e.g., receives signals) from or otherwise operates in connection with the telemetry monitor 725 to performs the orchestration of a reconfiguration identified or triggered by the telemetry monitor 725. In some implementations, the topology manager 730 may receive a reconfiguration signal from the telemetry monitor 725 based on telemetry data collected and assessed using the telemetry monitor, which identifies one or more configuration attributes and/or associated system components (e.g., nodes 605b, 605c, etc.) associated with a performance issue (e.g., errors, saturation, latency, traffic, etc.) detected by the telemetry monitor 725 in the time-correlated telemetry data. The topology manager 730 may utilize topology definitions for the various application being monitored to understand the subset of system components used in transactions of the application and the data flow of the application. The topology manager 730 may receive a signal from the telemetry monitor 725 indicating a specific performance issue affecting the application 750 and may trigger the stoppage and/or reconfiguration of the application and/or various system components implicated in the performance issues. For instance, the topology manager 730 may stop an application or its component services (or put them on hold) and manage the deployment or redeployment of the application based on the topology definition and information relating to the topology to identify substitute services or components (e.g., other instances of a service or accelerator, alternative network or interconnect pathways, etc.) that may be applied to reconfigure the application 750 within the system. In some implementations, various components of a system may include agents (e.g., 760a-c), which may be accessed by the topology manager to send reconfiguration instructions to cause these agents (e.g., 760a-c) to perform reconfigurations with their respective domains (e.g., nodes 605a-c), In some implementations, the TEE 720 may be additionally leveraged to authenticate the topology manager 730 and the agents (e.g., 760a-c) to each other. In one example, the TEE 720 may be used to provision licenses to individual autonomous agents used to configure application deployment, on a granular level, to determine and define the range of configuration change an individual agent is allowed to modify. A TEE 720 may additionally perform remote attestation, metering, and secure communication between the agents (e.g., as well with a corresponding edge orchestrator node), among other examples.

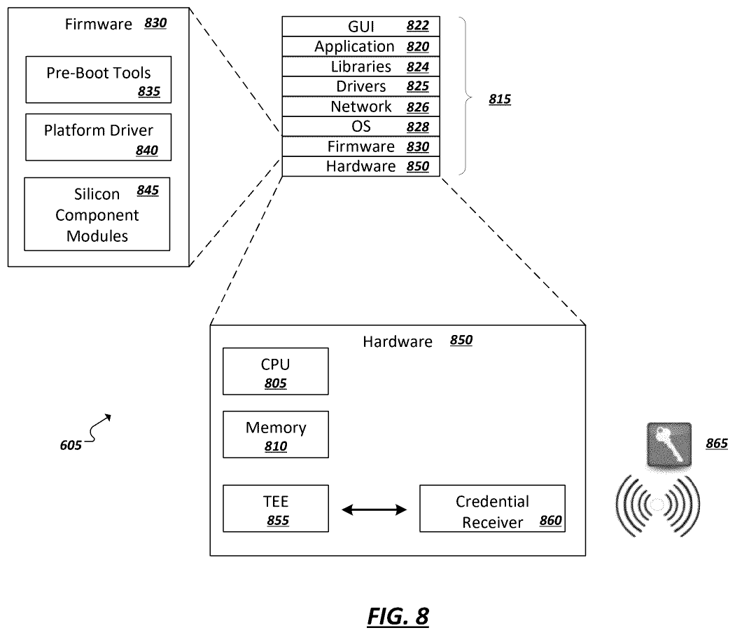

Turning to FIG. 8, a simplified block diagram is shown illustrating an example compute node (e.g., 605), which may include one or more XPUs (e.g., 805), one or more memory blocks (e.g., 810), and potentially other hardware components, such as hardware accelerator device coupled to the XPU, and interfaces to couple with other nodes in a cluster. A software stack 815 may be implemented on the node 605 to implement a software component, such as an application, service, microservice, etc. (e.g., 820). The software stack may include layers such as the user interface 822, application 820, libraries 824, drivers 825, network layer 826, operating system 8282, firmware 830 (e.g., including pre-boot tools 835, platform drivers 840, silicon component modules 845, among other examples), and portions of the local hardware 850). In-band telemetry data may be captured by sensors within the software stack 815 for the various software components in the software stack 815, such as the firmware, operating system, drivers, libraries, etc. Telemetry data may also be captured for the various hardware components of the node 605, such as the XPU (e.g., 805), memory (e.g., 810), I/O, accelerator(s), on-node interconnects (e.g., coupling the XPU to the memory, accelerators, and I/O subsystem, etc.), among other examples.

In some implementations, an application (e.g., 820) executed on the node 605 may involve calls to external devices, including other nodes and/or XPUs over various interconnects, networks, and appliances. Additional out-of-band telemetry may be captured from such components. The collective in-band and out-of-band telemetry may be sent to an example telemetry manager, along with timestamp data indicating synchronized timestamps corresponding to the events corresponding to the various in-band and out-of-band telemetry data. The telemetry manager may use these time-stamps, along with information regarding the topology and/or data flow of the application 820 to identify a subset of the collected telemetry data (both in-band and out-of-band) that correspond to the application's workload(s). The telemetry manager may utilize this information, in some instances, to determine a reconfiguration for the application that takes into account bottlenecks and other performance opportunities identified in the telemetry data to improve the functioning of the application within a system (e.g., which may include only the node 605 or the node functioning in coordination with other computing device and system (e.g., in a data center, cloud computing environment, edge computing environment, etc.). When such opportunities are identified, the telemetry manager may communicate with various agents on the node and/or one or more other subsystems used by the application, where the reconfiguration of the application should take place. In some cases, the telemetry manager may rely on encryption, remote attestation, and other techniques to determine whether these agents are trusted, before directing them to perform portions of the reconfiguration in a trusted manner. With the application reconfigured, the application may be allowed to relaunch or continue to run (with further telemetry data being captured) to determine whether these reconfigurations enhanced the performance of the application or not.

In some implementations, to assist in providing the sharing of remote telemetry data and/or coordinating with agents to perform a reconfiguration of an application topology, hardware 850 of the node 605 may include hardware 855 to implement a trusted execution environment (TEE). The TEE 855 can be utilized to process telemetry data from remote or other sources, which may include sensitive or private data, which a telemetry source would not otherwise share, were the data not to be processed in a TEE or similar hardened security environment. In some implementations, all or a portion of a telemetry manager may be executed within the TEE 855. A TEE 855 may also be utilized to perform attestations or other trust verifications with agents, which the telemetry manager (or the application) may call upon to perform reconfiguration tasks in association with observations in in-band and out-of-band telemetry data collected for the application.

The conditions for the use of a TEE 855 in executing portions of a telemetry manager workload and/or performing attestations of reconfiguration agents, may be based on certain defined credentials (e.g., which allow the TEE to be granted access to telemetry data from other systems and application workloads) and policies. Policies and credentials may be specific to a certain computing domain, node or cluster owner, geolocation, etc. Accordingly, the collection and processing of certain telemetry data (e.g., out-of-band) from various system elements may be based on an identification, by the telemetry manager, of policies applicable to that telemetry data, as well as the TEE's possession of attestation credentials so as to properly request, process, and store such telemetry data. In some implementations, a TEE 855 may be provided with certain attestation credentials at manufacturing time. However, to be granted access to certain telemetry sources and/or reconfiguration agents, the TEE 855 may need updated credentials corresponding to these systems. In one example, hardware 850 may include a credential acquisition engine or receiver 860 to receive updated TEE credentials from an administrator system (via a credential provisioning device 865) corresponding to one or more sources of telemetry data (e.g., out-of-band telemetry data) and/or reconfiguration agents deployed within a system (and external to the node 605). In one example, the credential provisioning device 865 may transmit credentials to a credential acquisition engine 860 over a radio-frequency (RF) channel (e.g., such that the credential exchange is at least partially conditioned on trust based on physical proximity or presentation of the device hosting the telemetry manager), among other examples. New credentials may be provided (and validated using the credential acquisition engine 860) for use by the TEE 855 to authenticate to or perform an attestation with other system elements (e.g., to allow the sharing of certain sensitive telemetry data, to determine what (if any) encryption or other security measures should be applied to the collection of telemetry data or the triggering of a reconfiguration of an application topology, among other examples).

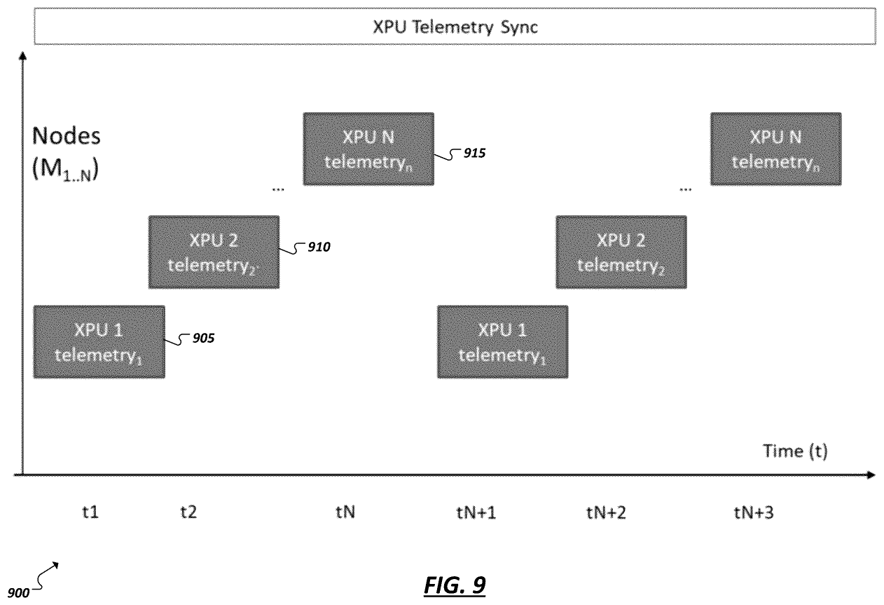

Turning to FIG. 9, a diagram 900 is shown illustrating the example time-based correlation, which may be performed by a telemetry manager, to determine that certain out-of-band telemetry data collected by the telemetry manager (e.g., from local and/or remote telemetry sources) applies to given in-band telemetry data of an application's software stack. In this example, an application's software stack may be principally implemented on a first XPU, but the application may also include calls to logic implemented on other XPUs (external to the first XPU and potentially coupled to the first XPUs via various wired and/or wireless communication channels). In one example, an application's data flow or topography may involve work by the first XPU (XPU 1) followed by work (e.g., responsive to a call by an application executed on the first XPU or other work performed on the first XPU) performed at the second XPU (XPU 2) and a third (or n^{th}) XPU (XPU N). In connection with this work, corresponding telemetry data 905, 910, 915 may be captured. The telemetry data (e.g., 905, 910, 915, etc.) may include in-band and out-of-band telemetry data and may be collected by or delivered to a telemetry manager (e.g., implemented on one of the nodes used in the execution of the application or another node or XPU). In one example, Time-Sensitive Network (TSN) protocols (e.g., as defined by standards of the IEEE 802.1 TSN Task Group) may be utilized to coordinate the sending of telemetry data from their respective sources to one or more telemetry managers in a system. High-precision, time-synchronized time stamps (e.g., based on or facilitated through a common clock, a Precision Time Protocol (PTP), White Rabbit, Chronos Protocol, Synchronous Ethernet (SyncE), or another mechanism) may be included within the telemetry data sent to the telemetry manager. With an understanding of the components involved in the application's workloads (e.g., XPU 1, XPU 2, and XPU N) and the data flow associated with these workloads, the telemetry manager may identify the respective subsets of telemetry data collected at these components that correspond to the in-band telemetry captured for the application. In the case of out-of-band telemetry data captured in association with XPU 1, XPU 2, or XPU N, such telemetry data may be related to multiple different concurrent processes and applications (e.g., multiple applications executed on a given XPU, the traffic of multiple applications over a network, multiple applications utilizing a shared memory resource or accelerator (e.g., in a virtualization of the hardware), etc.). As such, some out-of-band telemetry data may be correlated to multiple applications and their corresponding in-band telemetry data by the telemetry manager, among other examples.

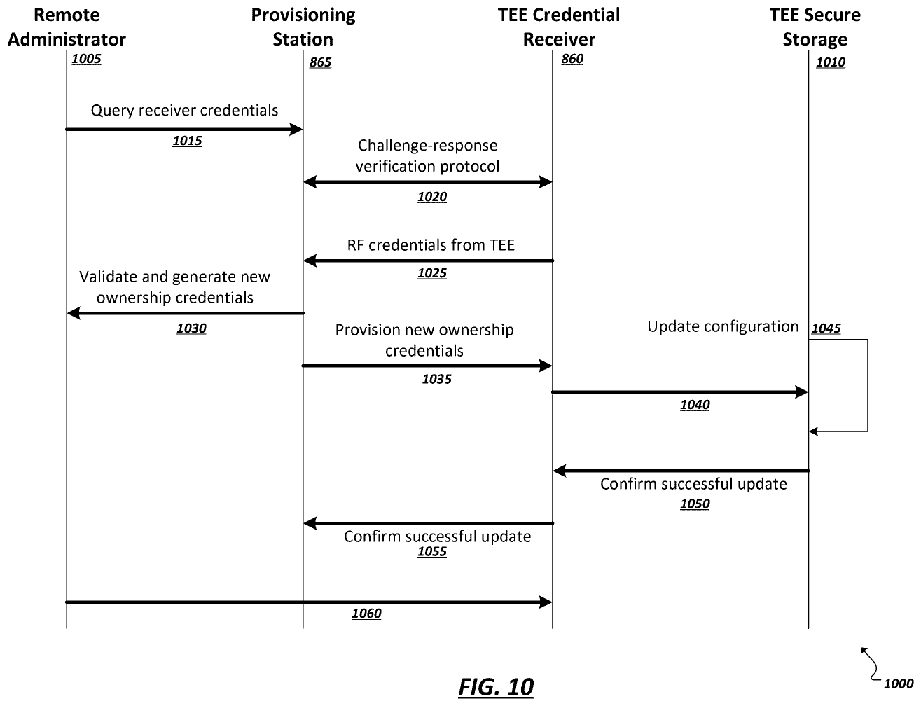

Turning to FIG. 10, a simplified flow diagram 1000 is shown illustrating an example provisioning of new or additional authentication credentials within a TEE 855 used in an example implementation of a telemetry manager (e.g., hosted in a BMC of a particular computing node (e.g., 605)). For instance, a TEE credential receiver device 860 (coupled to a TEE and thereby the TEE's secure storage 1010) may interface with a remote administration system 1005 in connection with a request or effort to obtain updated TEE credential for a given subsystem (e.g., and its corresponding telemetry sources and reconfiguration agents). The remove administrator system 1005 may attempt to perform a first level authentication of the TEE credential receiver 860 and/or the TEE to establish a baseline confirmation of the TEE. For instance, the remote administrator system 1005 may query for TEE credentials 1015 via a corresponding provision station device 865, which may engage in a challenge-response verification exchange 1020 with the TEE credential receiver 860. The TEE credential receiver 860 may obtain the existing TEE credentials and share these (at 1035) with the provisioning station 865 (e.g., Subscribed Identity Module (SIM) and/or Secure Shell (SSH) credentials over an RF channel). The remote administrator 1005 may validate the TEE and generate new ownership credentials for the TEE to add to allow the TEE to attest to the administrator system (and its components (e.g., telemetry sources and reconfiguration agents)) that the TEE (e.g., and thereby the telemetry manager processes executed within the TEE) is to be trusted. The provisioning station may provide the new credentials (at 035) to the TEE credential receiver 865 (e.g., over an RF channel, wired channel, or other transport mechanism), which the TEE credential receiver 865 may share (at 1040) with the TEE (and which the TEE may verify (e.g., through a signature verification) and update its credentials to include (at 1045)). Once verified and updated at the TEE (as confirmed at 1040), the TEE credential receiver 860 may be used to confirm the successful credential update to the provisioning station 865 (at 1055), for instance, using the same communication channel used to provide (at 1035) the new credentials. These updated credentials may then be used as the basis of attestations, encrypted communication channels, and other hardened security measures to enable interactions between an example telemetry manager (using the TEE) and external systems relying upon the administrator system, among other examples and features.

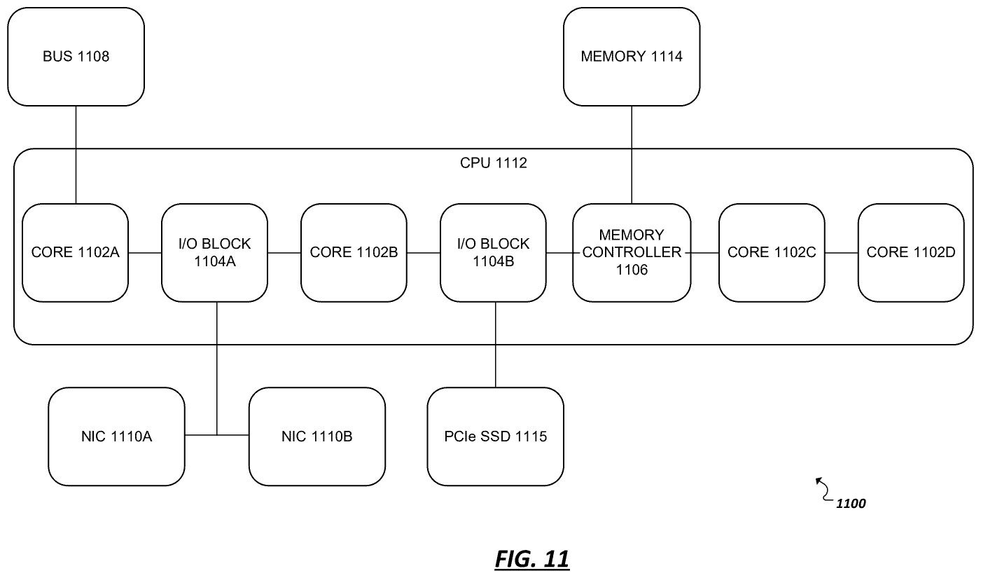

Note that the apparatus', methods', and systems described above may be implemented in any electronic device or system as aforementioned. As a specific illustration, FIG. 11 provides an exemplary implementation of a processing device such as one that may be included in a system or platform in a publish-subscribe architecture, such as discussed herein. It should be appreciated that other processor architectures may be provided to implement the functionality and processing of requests by an example network processing device, including the implementation of the example CDS device components and functionality discussed above.

Referring to FIG. 11, a block diagram 1100 is shown of an example data processor device (e.g., a central processing unit (CPU)) 1112 coupled to various other components of a platform in accordance with certain embodiments. Although CPU 1112 depicts a particular configuration, the cores and other components of CPU 1112 may be arranged in any suitable manner. CPU 1112 may comprise any processor or processing device, such as a microprocessor, an embedded processor, a digital signal processor (DSP), a network processor, an application processor, a co-processor, a system on a chip (SOC), or other device to execute code. CPU 1112, in the depicted embodiment, includes four processing elements (cores 1102 in the depicted embodiment), which may include asymmetric processing elements or symmetric processing elements. However, CPU 1112 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 1112, as illustrated in FIG. 11, includes four cores-cores 1102A, 1102B, 1102C, and 1102D, though a CPU may include any suitable number of cores. Here, cores 1102 may be considered symmetric cores. In another embodiment, cores may include one or more out-of-order processor cores or one or more in-order processor cores. However, cores 1102 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 1102 may include a decode module coupled to a fetch unit to decode fetched elements. Fetch logic, in one embodiment, includes individual sequencers associated with thread slots of cores 1102. Usually a core 1102 is associated with a first ISA, which defines/specifies instructions executable on core 1102. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, decoders may, in one embodiment, include logic designed or adapted to recognize specific instructions, such as transactional instructions. As a result of the recognition by the decoders, the architecture of core 1102 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 1102, in one embodiment, recognize the same ISA (or a subset thereof). Alternatively, in a heterogeneous core environment, a decoder of one or more cores (e.g., core 1102B) may recognize a second ISA (either a subset of the first ISA or a distinct ISA).

In various embodiments, cores 1102 may also include one or more arithmetic logic units (ALUs), floating point units (FPUs), caches, instruction pipelines, interrupt handling hardware, registers, or other suitable hardware to facilitate the operations of the cores 1102.

Bus 1108 may represent any suitable interconnect coupled to CPU 1112. In one example, bus 1108 may couple CPU 1112 to another CPU of platform logic (e.g., via UPI). I/O blocks 1104 represents interfacing logic to couple I/O devices 1110 and 1115 to cores of CPU 1112. In various embodiments, an I/O block 1104 may include an I/O controller that is integrated onto the same package as cores 1102 or may simply include interfacing logic to couple to an I/O controller that is located off-chip. As one example, I/O blocks 1104 may include PCIe interfacing logic. Similarly, memory controller 1106 represents interfacing logic to couple memory 1114 to cores of CPU 1112. In various embodiments, memory controller 1106 is integrated onto the same package as cores 1102. In alternative embodiments, a memory controller could be located off chip.

As various examples, in the embodiment depicted, core 1102A may have a relatively high bandwidth and lower latency to devices coupled to bus 1108 (e.g., other CPUs 1112) and to NICs 1110, but a relatively low bandwidth and higher latency to memory 1114 or core 1102D. Core 1102B may have relatively high bandwidths and low latency to both NICs 1110 and PCIe solid state drive (SSD) 1115 and moderate bandwidths and latencies to devices coupled to bus 1108 and core 1102D. Core 1102C would have relatively high bandwidths and low latencies to memory 1114 and core 1102D. Finally, core 1102D would have a relatively high bandwidth and low latency to core 1102C, but relatively low bandwidths and high latencies to NICs 1110, core 1102A, and devices coupled to bus 1108.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stages, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, HDL, and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of a system on chip (SoC) and other hardware devices. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, such as reset, while an updated value potentially includes a low logical value, such as set. Note that any combination of values may be utilized to represent any number of states.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: a processor; a telemetry manager executable by the processor to: identify a plurality of telemetry sources associated with a plurality of different hardware components in a system, where the plurality of telemetry sources generate in-band telemetry data and out-of-band telemetry data for an application, where the plurality of different hardware components include a plurality of processor devices, and the application is executed on a given processor device in the plurality of processor devices; identify a subset of hardware components in the plurality of hardware components of the system used to handle workloads of the application; correlate telemetry data from the plurality of telemetry sources in association with the execution of the application and the workloads handled by the subset of hardware components; and trigger a reconfiguration of at least one of the application or the subset of hardware components based on correlation of the telemetry data.

Example 2 includes the subject matter of example 1, where the telemetry manager is further to identify a data flow between the subset of hardware components for the workloads of the application, and the telemetry data is correlated based on the data flow.

Example 3 includes the subject matter of any one of examples 1-2, where the telemetry manager correlates the telemetry data associated with the application based on a time-based correlation.

Example 4 includes the subject matter of example 3, where the out-of-band telemetry data includes timestamp data, and the out-of-band telemetry data is correlated with the in-band telemetry data based on the timestamp data.

Example 5 includes the subject matter of example 4, where the timestamp data is based on a Precision Time Protocol (PTP).

Example 6 includes the subject matter of any one of examples 1-5, where the in-band telemetry data is generated by telemetry sources for a software stack of the application, and the out-of-band telemetry data is generated for the subset of hardware components external to the software stack of the application.

Example 7 includes the subject matter of example 6, where the out-of-band telemetry data includes telemetry data generated for a different application executed in the system, where the different application is executed using at least a portion of the subset of hardware components.

Example 8 includes the subject matter of any one of examples 6-7, where the out-of-band telemetry data includes telemetry data generated for at least one of an accelerator, a network element, an I/O element, or memory element in the subset of hardware components.

Example 9 includes the subject matter of example 8, where the subset of hardware components is external to the given processor device.

Example 10 includes the subject matter of any one of examples 1-9, further including trusted execution environment (TEE) hardware to execute at least a portion of the telemetry manager.

Example 11 includes the subject matter of example 10, where correlation of at least a portion of telemetry data is performed using the TEE hardware.

Example 12 includes the subject matter of example 11, where the portion of the telemetry data includes private information.

Example 13 includes the subject matter of any one of examples 10-12, where the TEE hardware is to perform an attestation with at least one of the plurality of telemetry sources.

Example 14 includes the subject matter of example 13, where the TEE hardware is to acquire a credential through a credential provisioner associated with at least one of the plurality of telemetry sources to perform the attestation.

Example 15 includes the subject matter of any one of examples 1-14, where the plurality of processor device include at least two processor devices of different processor device types.

Example 16 includes the subject matter of any one of examples 1-15, where the telemetry manager is implemented in a baseboard management controller.

Example 17 is a non-transitory machine-readable storage medium with instructions stored thereon, the instructions executable by a machine to cause the machine to: receive, from a plurality of telemetry sources in a system, telemetry data, where the telemetry data describes a plurality of different hardware components in a system, and the telemetry data includes in-band telemetry data and out-of-band telemetry data for an application, where the plurality of different hardware components include a plurality of processor devices, and the application is executed on a given processor device in the plurality of processor devices; determine data flows of the application, where the data flows include work by a subset of hardware components in the plurality of hardware components of the system; correlate the in-band telemetry data with the out-of-band telemetry data based on timestamp data in the out-of-band telemetry data to identify a subset of the telemetry data corresponding to the application; determine a performance impact to the application based on the subset of the telemetry data; and trigger a reconfiguration of at least one of the application or the subset of hardware components based on the performance impact.

Example 18 includes the subject matter of example 17, where at least a portion of the instructions are executed within a trusted execution environment (TEE).

Example 19 includes the subject matter of any one of examples 17-18, where the instructions are further executable to cause the machine to send reconfiguration messages to reconfiguration agents associated with the subset of hardware components.

Example 20 includes the subject matter of example 19, where the instructions are further executable to cause the machine to perform an attestation with the reconfiguration agents prior to sending the reconfiguration messages.

Example 21 includes the subject matter of any one of examples 17-20, where the timestamp data is based on a Precision Time Protocol (PTP).

Example 22 includes the subject matter of any one of examples 17-21, where the in-band telemetry data is generated by telemetry sources for a software stack of the application, and the out-of-band telemetry data is generated for the subset of hardware components external to the software stack of the application.

Example 23 includes the subject matter of example 22, where the out-of-band telemetry data includes telemetry data generated for a different application executed in the system, where the different application is executed using at least a portion of the subset of hardware components.

Example 24 includes the subject matter of example 22, where the out-of-band telemetry data includes telemetry data generated for at least one of an accelerator, a network element, an I/O element, or memory element in the subset of hardware components.

Example 25 includes the subject matter of example 24, where the subset of hardware components is external to the given processor device.

Example 26 includes the subject matter of any one of examples 17-25, where the plurality of processor device include at least two processor devices of different processor device types.

Example 27 is a method including: receiving, from a plurality of telemetry sources in a system, telemetry data describing a plurality of different hardware components in a system, where the telemetry data includes in-band telemetry data and out-of-band telemetry data for an application, the plurality of different hardware components include a plurality of processor devices, and the application is executed on a given processor device in the plurality of processor devices; determining data flows of the application, where the data flows include work by a subset of hardware components in the plurality of hardware components of the system; correlating the in-band telemetry data with the out-of-band telemetry data based on timestamp data in the out-of-band telemetry data to identify a subset of the telemetry data corresponding to the application; determining a performance impact to the application based on the subset of the telemetry data; and triggering a reconfiguration of at least one of the application or the subset of hardware components based on the performance impact.

Example 28 includes the subject matter of example 27, where at least a portion of the method is performed within a trusted execution environment (TEE).

Example 29 includes the subject matter of any one of examples 27-28, further including sending reconfiguration messages to reconfiguration agents associated with the subset of hardware components.

Example 30 includes the subject matter of example 29, further including performing an attestation with the reconfiguration agents prior to sending the reconfiguration messages.

Example 31 includes the subject matter of any one of examples 27-30, where the timestamp data is based on a Precision Time Protocol (PTP).

Example 32 includes the subject matter of any one of examples 27-31, where the in-band telemetry data is generated by telemetry sources for a software stack of the application, and the out-of-band telemetry data is generated for the subset of hardware components external to the software stack of the application.

Example 33 includes the subject matter of example 31, where the out-of-band telemetry data includes telemetry data generated for a different application executed in the system, where the different application is executed using at least a portion of the subset of hardware components.

Example 34 includes the subject matter of example 31, where the out-of-band telemetry data includes telemetry data generated for at least one of an accelerator, a network element, an I/O element, or memory element in the subset of hardware components.

Example 35 includes the subject matter of example 34, where the subset of hardware components is external to the given processor device.

Example 36 includes the subject matter of any one of examples 27-35, where the plurality of processor device include at least two processor devices of different processor device types.

Example 37 is a system including means to perform the method of any one of examples 27-36.

Example 38 includes the subject matter of example 37, where the means include a baseboard management controller.

Example 39 is a system including: a plurality of processors, where a given one of the plurality of processors hosts an application, and the plurality of processors are interconnected in a network; a telemetry manager executable to: identify a plurality of telemetry sources associated with the plurality of processor devices and the network, where the plurality of telemetry sources generate in-band telemetry data and out-of-band telemetry data for the application; identify a data flow of the application; correlate the in-band telemetry data with the out-of-band telemetry data based on timestamp data in the out-of-band telemetry data to identify a subset of the telemetry data corresponding to the application; determine a performance impact to the application based on the subset of the telemetry data; and trigger a reconfiguration of the application based on the performance impact.

Example 40 includes the subject matter of example 39, further including a set of reconfiguration agents to perform reconfiguration of corresponding components involved in the data flow, where the telemetry manager triggers the reconfiguration through instructions to one or more of the set of reconfiguration agents.

Example 41 includes the subject matter of any one of examples 39-40, further including a trusted execution environment, where the TEE is used to perform at least one of the correlation of the in-band telemetry data with the out-of-band telemetry data or the determination of the performance impact to the application.

Example 42 includes the subject matter of any one of examples 39-41, where the application is one of a plurality of applications executed concurrently by the plurality of processors, and the telemetry manager performs respective correlations of in-band and out-of-band telemetry data for the plurality of applications.

Example 43 includes the subject matter of any one of examples 39-42, where the timestamp data is based on a Precision Time Protocol (PTP).

Example 44 includes the subject matter of any one of examples 39-43, where the in-band telemetry data is generated by telemetry sources for a software stack of the application, and the out-of-band telemetry data is generated for the subset of hardware components external to the software stack of the application.

Example 45 includes the subject matter of example 44, where the out-of-band telemetry data includes telemetry data generated for a different application executed in the system, where the different application is executed using at least a portion of the subset of hardware components.

Example 46 includes the subject matter of any one of examples 44-45, where the out-of-band telemetry data includes telemetry data generated for at least one of an accelerator, a network element, an I/O element, or memory element in the subset of hardware components.

Example 47 includes the subject matter of example 46, where the subset of hardware components is external to the given processor device.

Example 48 includes the subject matter of any one of examples 39-47, where the plurality of processor device include at least two processor devices of different processor device types.

Example 49 includes the subject matter of any one of examples 39-47, where the telemetry manager is implemented in a baseboard management controller.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplary language does not necessarily refer to the same embodiment or the same example, but may refer to different and distinct embodiments, as well as potentially the same embodiment.

What is claimed is:

1. An apparatus comprising:
a processor;
a telemetry manager, comprising instructions executable by the processor to:
identify a plurality of telemetry sources associated with a plurality of different hardware components in a system, wherein the plurality of telemetry sources generate in-band telemetry data and out-of-band telemetry data for an application, wherein the plurality of different hardware components comprise a plurality of processor devices, and the application is executed on a given processor device in the plurality of processor devices;
identify a subset of hardware components in the plurality of hardware components of the system used to handle workloads of the application;
correlate telemetry data from the plurality of telemetry sources in association with the execution of the application and the workloads handled by the subset of hardware components; and
trigger a reconfiguration of at least one of the application or the subset of hardware components based on correlation of the telemetry data.

2. The apparatus of claim 1, wherein the telemetry manager is further to identify a data flow between the subset of hardware components for the workloads of the application, and the telemetry data is correlated based on the data flow.

3. The apparatus of claim 1, wherein the telemetry manager correlates the telemetry data associated with the application based on a time-based correlation.

4. The apparatus of claim 3, wherein the out-of-band telemetry data comprises timestamp data, and the out-of-band telemetry data is correlated with the in-band telemetry data based on the timestamp data.

5. The apparatus of claim 4, wherein the timestamp data is based on a Precision Time Protocol (PTP).

6. The apparatus of claim 1, wherein the in-band telemetry data is generated by telemetry sources for a software stack of the application, and the out-of-band telemetry data is generated for the subset of hardware components external to the software stack of the application.

7. The apparatus of claim 6, wherein the out-of-band telemetry data comprises telemetry data generated for a different application executed in the system, wherein the different application is executed using at least a portion of the subset of hardware components.

8. The apparatus of claim 6, wherein the out-of-band telemetry data comprises telemetry data generated for at least one of an accelerator, a network element, an I/O element, or memory element in the subset of hardware components.

9. The apparatus of claim 8, wherein the subset of hardware components is external to the given processor device.

10. The apparatus of claim 1, further comprising trusted execution environment (TEE) hardware to execute at least a portion of the telemetry manager.

11. The apparatus of claim 10, wherein correlation of at least a portion of telemetry data is performed using the TEE hardware.

12. The apparatus of claim 11, wherein the portion of the telemetry data comprises private information.

13. The apparatus of claim 1, wherein the plurality of processor device comprise at least two processor devices of different processor device types.

14. The apparatus of claim 1, wherein the telemetry manager is implemented in a baseboard management controller.

15. A method comprising:
receiving, from a plurality of telemetry sources in a system, telemetry data describing a plurality of different hardware components in a system, wherein the telemetry data comprises in-band telemetry data and out-of-band telemetry data for an application, the plurality of different hardware components comprise a plurality of processor devices, and the application is executed on a given processor device in the plurality of processor devices;
determining data flows of the application, wherein the data flows comprise work by a subset of hardware components in the plurality of hardware components of the system;
correlating the in-band telemetry data with the out-of-band telemetry data based on timestamp data in the out-of-band telemetry data to identify a subset of the telemetry data corresponding to the application;
determining a performance impact to the application based on the subset of the telemetry data; and
triggering a reconfiguration of at least one of the application or the subset of hardware components based on the performance impact.

16. The method of claim 15, further comprising sending reconfiguration messages to reconfiguration agents associated with the subset of hardware components to trigger the reconfiguration.

17. A system comprising:
a plurality of processors, wherein a given one of the plurality of processors hosts an application, and the plurality of processors are interconnected in a network;
a telemetry manager executable to:
identify a plurality of telemetry sources associated with the plurality of processor devices and the network, wherein the plurality of telemetry sources generate in-band telemetry data and out-of-band telemetry data for the application;
identify a data flow of the application;
correlate the in-band telemetry data with the out-of-band telemetry data based on timestamp data in the out-of-band telemetry data to identify a subset of the telemetry data corresponding to the application;
determine a performance impact to the application based on the subset of the telemetry data; and
trigger a reconfiguration of the application based on the performance impact.

18. The system of claim 17, further comprising a set of reconfiguration agents to perform reconfiguration of corresponding components involved in the data flow, wherein the telemetry manager triggers the reconfiguration through instructions to one or more of the set of reconfiguration agents.

19. The system of claim 17, further comprising a trusted execution environment (TEE), wherein the TEE is used to perform at least one of the correlation of the in-band telemetry data with the out-of-band telemetry data or the determination of the performance impact to the application.

20. The system of claim 17, wherein the application is one of a plurality of applications executed concurrently by the plurality of processors, and the telemetry manager performs respective correlations of in-band and out-of-band telemetry data for the plurality of applications.
